(19) United States
(12) Patent Application Publication
(10) Pub. No.: US 2015/0200546 A1
(43) Pub. Date: Jul. 16, 2015

(54) Perpetual Power Generator

(71) Applicant: Wayne Patrick Demar, Hollywood, FL (US)

(72) Inventor: Wayne Patrick Demar, Hollywood, FL (US)

(21) Appl. No.: 14/156,393

(22) Filed: Jan. 15, 2014

(51) Int. Cl. H02J 5/00

(52) U.S. Cl. CPC H02J 5/00; Y10S 74/09; H02K 53/00

(57) ABSTRACT

An electro-mechanical device that can generate 120V AC electricity and operate on its own rechargeable power source. The unit would generate enough power to recharge its power source and provide AC power at the same time, making it perpetual in operation. It would not require any external power to operate at all.

This is in reference to application Ser. No. 14/156,393, filed 15 Jan. 2014. EFS ID: EFS ID 17926519

### BACKGROUND OF THE INVENTION

This Perpetual Power Generator is capable of generating BOTH Alternating, (AC) and Direct Current, (DC) power—without the need for an EXTERNAL fuel or power source to recharge it. The design uses existing shelf bought technologies, but setup in a unique manner, that allows it to generate power AND recharge its own power generating source.

This unit is completely SCALEABLE, so power output can range from 100 W to 10 KW or more—depending on components used in a similar design setup. Applications for this design include, (but not limited to): portable backup power generators, fixed main home power generators, mobile or field power generators, electric automobiles, electric aircraft, electric boats etc. The included diagram illustrates the layout of the unit's components. Power output will depend on the number of alternators used, number of batteries used and the specifications of the dc to ac power inverter.

### SUMMARY OF INVENTION

The prototype unit comprises the following components: 2 automobile power alternators, rated at 110 Amps @ 12 Volts DC, a 220 Volt, ½ HP motor, which turns the alternators, 1 step up power transformer, which converts 110V to 220V for powering the ½HP motor. 2 rechargeable 12 Volt, lead acid batteries, 2 12 Volt DC to 110 Volt AC power inverter(s) and an on/off switch.

The unit will be belt driven—which will mechanically connect the motor to the alternators. Power generated from the alternators will go to a lead acid or other type of RECHARGEABLE battery. Power from the battery can be directly connected to the end use item or be tapped from the DC to AC power inverter, which will also be connected to the battery. Each inverter used in this prototype can provide 1,000 Watts of PURE SINE WAVE AC power.

### BRIEF DESCRIPTION OF THE DRAWINGS

FIG. 1 Shows the frontal view of the mechanical layout of the components and how they are connected to each other, using 2AWG, (10), auto battery cables. The ½ HP motor (1) will be turning two alternators, (4,5) via 6″ pulley, (2), and drive belt, (3). The motor will be plugged into one of the two inverters, (8a or 8b), used via the 110 Volt-220 Volt power transformer, (9), and on/off switch shown in FIG. 2, (11).

### DETAILED DESCRIPTION OF THE MACHINE'S OPERATION

A—Power is INITIALLY provided by the 12 Volt DC batteries, which will provide power to the two DC to AC inverters.

B—Each PURE SINE WAVE inverter will convert the 12 Volt DC power from the batteries, to 110-120 Volt AC power.

C—This power will then supply power to the ½ HP 220 Volt AC motor via the 110 Volt-220 Volt transformer and on/off switch.

D—This motor will be connected mechanically to the two auto alternators by way of a 6″ pulley mounted on the motor and belt.

E—The belt will turn each alternator once the motor is switched on.

F—Once the alternators begin to turn, power will be generated from them.

G—This power will be sent to the DC batteries and will vary according to the SPEED of the ½ HP motor.

H—This power will range from 1 Amp×12 Volts=12 Watts to 110 Amps×12 Volts=1,320 Watts.

I—This power generated will charge the batteries AND provide power to the inverters—in the same manner that an automobile engine can operate WITHOUT the battery, and rely solely on the power supplied by the alternator, once the engine is started.

H—This configuration should run INDEFINITELY—with an expected life of the batteries being approximately 5-7 years.

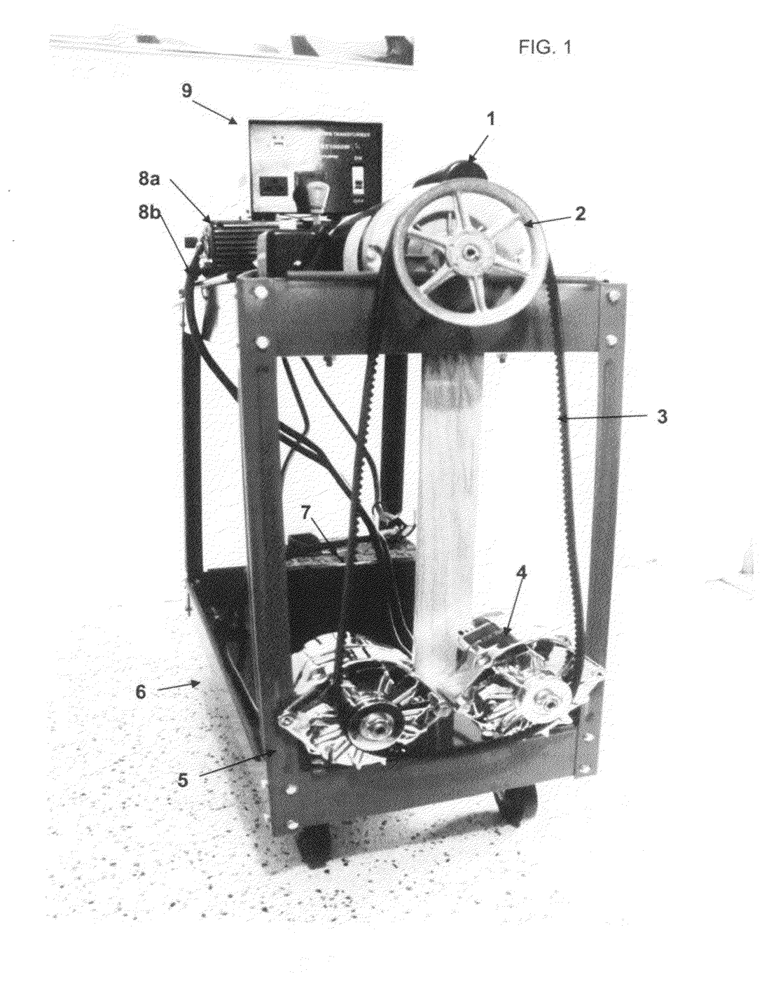

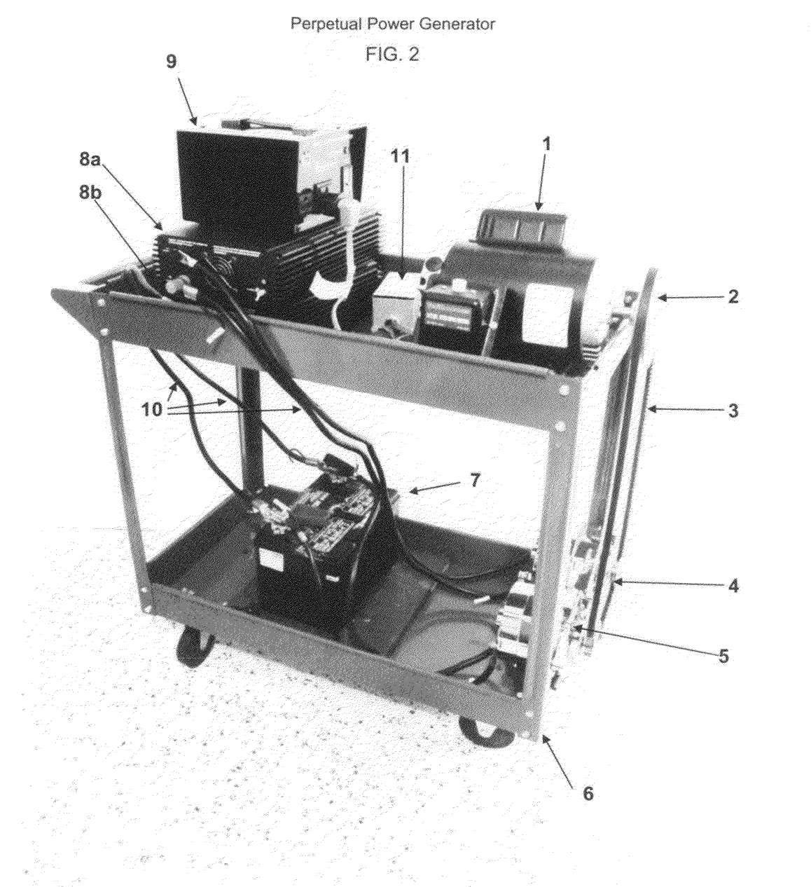

### LIST OF COMPONENTS SHOWN IN FIGS. 1, 2

1—½ HP motor
2—6″ Pulley
3—drive belt
4—Alternator
5—Alternator
6—Housing
7—Automobile battery
8a—Power Inverter
8b—Power Inverter
9—Power Transformer
10—2 AWG automobile battery cables
11—on/off switch connected to the ½ HP motor

1. A Perpetual Power Generator assembly, providing 12 Volts DC or 110 Volts AC, with said components used in this assembly comprising:
2 Automobile Alternators, 2, 12 Volt DC lead acid batteries, 2 DC to AC Pure Sine Wave Inverters, a ½ HP motor, 1 6″ pulley mounted on the motor, 1 rubber belt, 1 switch, 4 pairs of 2 AWG battery cables, cabinet housing where components are mounted.

2. The Perpetual Power Generator of claim 1 functions to generate BOTH 12 Volts DC and 110-120 Volts AC power, between the range of 12 to 1,300 Watts maximum.

3. That additional alternators, batteries and DC to AC power inverters can be added to this design to increase power generating capacity.

4. That the Perpetual Power Generator of claim 1 is a completely scalable design, capable of generating even more power than the prototype, and is only limited by the components used and their specifications.

5. That the Perpetual Power Generator will run indefinitely, unless battery, alternator, motor or other component fails.

6. That the Perpetual Power Generator will not rely on any external power source to recharge the batteries and will be fully self sufficient, and be able to generate power and charge its power source batteries.
